(19) United States
(12) Patent Application Publication
(10) Pub. No.: US 2015/0075842 A1
(43) Pub. Date: Mar. 19, 2015

(54) SEMICONDUCTOR DEVICE COMPONENT, SEMICONDUCTOR DEVICE, AND SEMICONDUCTOR DEVICE TERMINAL

(71) Applicant: KABUSHIKI KAISHA TOSHIBA, Tokyo (JP)

(72) Inventor: Eitaro MIYAKE, Hyogo (JP)

(73) Assignee: KABUSHIKI KAISHA TOSHIBA, Tokyo (JP)

(21) Appl. No.: 14/194,338

(22) Filed: Feb. 28, 2014

(30) Foreign Application Priority Data
Sep. 13, 2013 (JP) 2013-190796

(51) Int. Cl. H01R 4/02

(52) U.S. Cl. CPC H01R 4/023
USPC 174/126.1

(57) ABSTRACT

A semiconductor device component includes a mounting substrate, a first connection terminal disposed on the mounting substrate, having a shape extending in a first direction, and including a first U-shaped portion having a U-shaped cross-sectional shape cut along a plane perpendicular to the first direction, and a second connection terminal, disposed on the mounting substrate, adjacent to the first connection terminal, having a shape extending in a second direction not parallel with the first direction, and including a second U-shaped portion having a U-shaped cross-sectional shape cut along a plane perpendicular to the second direction. Further, the first connection terminal is disposed in such a position that the U-shaped base of the first U-shaped portion is located on a second connection terminal side. The second connection terminal is disposed in such a position that the U-shaped base of the second U-shaped portion is located on a first connection terminal side.

### CROSS-REFERENCE TO RELATED APPLICATION

This application is based upon and claims the benefit of priority from Japanese Patent Application No. 2013-190796, filed Sep. 13, 2013, the entire contents of which are incorporated herein by reference.

### FIELD

Embodiments described herein relate generally to a semiconductor device component, a semiconductor device, and a semiconductor device terminal.

### BACKGROUND

A typical pressure-welded semiconductor device is connected to a signal line and a shield line of a coaxial cable using two external terminals of the semiconductor device. Using this arrangement, if a long loop constituted by the signal line and the shield line occurs in the vicinity of the external terminals, it can cause a low inductance failure of the device or generation of noise in the output of the device. To overcome this problem, the use of a printed circuit board (mounting substrate) for connection with the external terminals is currently under consideration. However, the position and alignment of the external terminals on the pressure-welded semiconductor device is such that the two terminals extending in directions not parallel with each other (more specifically, in a radial direction from the center of the device) makes it difficult to directly connect the external terminals to the printed circuit board by soldering or other methods. It is therefore desired to provide connection terminals of a printed circuit board that are capable of being connected to the external terminals.

### DESCRIPTION OF THE DRAWINGS

FIGS. 1A and 1B are a perspective view and a plan view, respectively, illustrating the structure of a semiconductor device according to a first embodiment.

FIGS. 2A and 2B are a perspective view and a plan view, respectively, illustrating the structure of a semiconductor device component according to the first embodiment.

FIGS. 3A and 3B are a perspective view and a cross-sectional view, respectively, illustrating the structure of a second connection terminal according to the first embodiment.

FIG. 4 is a side view illustrating the structure of a semiconductor device component according to a modified example of the first embodiment.

### DETAILED DESCRIPTION

Embodiments provide a semiconductor device component, a semiconductor device, a semiconductor device terminal that can be easily connected to external terminals not disposed in parallel with each other, and a mounting substrate.

According to one embodiment, a semiconductor device component includes: a mounting substrate; a first connection terminal disposed on the mounting substrate, having a shape extending in a first direction parallel with a surface of the mounting substrate, and including a first U-shaped (concave) portion having a U-shaped cross-sectional shape cut along a plane perpendicular to the first direction; and a second connection terminal, disposed on the mounting substrate, adjacent to the first connection terminal, having a shape extending in a second direction parallel with the surface of the mounting substrate and not parallel with the first direction, and including a second U-shaped (concave) portion having a U-shaped cross-sectional shape cut along a plane perpendicular to the second direction. The first connection terminal is disposed in such a position that the U-shape base of the first U-shaped portion is located on a second connection terminal side. The second connection terminal is disposed in such a position that the U-shape base of the second U-shaped portion is located on a first connection terminal side, i.e., the open sides of the U-shaped portions face one another.

An exemplary embodiment is hereinafter described with reference to the drawings.

### First Embodiment

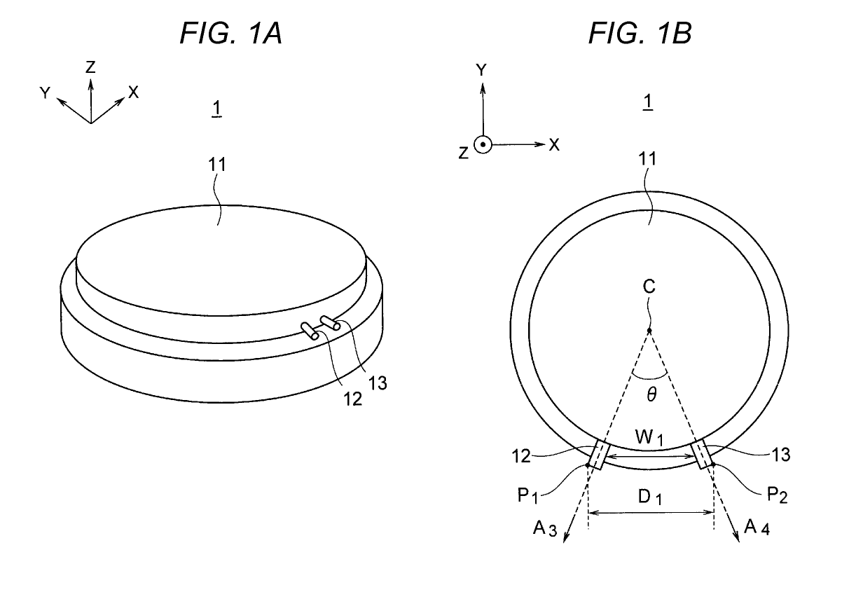

FIGS. 1A and 1B are a perspective view and a plan view, respectively, illustrating the structure of a semiconductor device 1 according to a first embodiment. FIG. 1A is a perspective view of the semiconductor device 1, while FIG. 1B is a plan view of the semiconductor device 1.

The semiconductor device 1 according to this embodiment is a pressure-welded semiconductor device, for example, and includes a main body 11, and first and second external terminals 12 and 13.

The main body 11 includes a semiconductor chip equipped with a power transistor such as an IGBT (insulated gate bipolar transistor), a housing case made of a ceramic for accommodating the semiconductor chip, and other components. In FIGS. 1A and 1B, an X direction and a Y direction are defined as directions extending in parallel with the front surface and the base surface of the main body 11 and crossing each other at right angles, while a Z direction is defined as a direction perpendicular to the front surface and the base surface of the main body 11. The planar shape of the main body 11 is substantially circular with the center of the circle located at a point C (FIG. 1B).

According to this disclosure, the +Z direction corresponds to the upward direction, while the −Z direction corresponds to the downward direction. For example, the upper surface of the main body 11 refers to the +Z side surface of the main body 11, while the lower surface (the side surface not visible in FIG. 1A) of the main body 11 refers to the −Z side surface of the main body 11.

The first external terminal 12 is provided on the side surface of the main body 11, and has a bar shape extending radially, i.e., on a radius extending through the center point C, from the side surface of the main body 11. The first external terminal 12 projects in direction A₃ as shown in FIG. 1B. The cross-sectional shape of the first external terminal 12 in a plane perpendicular to the A₃ direction is concave.

The second external terminal 13 is disposed on the side surface of the main body 11 adjacent to the first external terminal 12, and has a bar shape extending radially from the side surface of the main body 11. The second external terminal 13 projects in direction A₄ which is not parallel with the A₃ direction, along a radius extending from the center point C. The cross-sectional shape of the second external terminal 13 in a plane perpendicular to the A₄ direction is semi-circular.

The reference symbol θ indicates the angle between the A₃ direction and the A₄ direction. The reference symbol W₁ indicates the distance between the first external terminal 12 and the second external terminal 13. According to this embodiment, the first and second external terminals 12 and 13 extend radially, therefore the distance W₁ increases along the length of the terminals in the direction away from the main body 11 (away from center point C).

Reference symbol P₁ indicates a point located on the distal end surface of the first external terminal 12 at a position farthest from the second external terminal 13. Similarly, reference symbol P₂ indicates a point located on the distal end surface of the second external terminal 13 at a position farthest from the first external terminal 12. Reference symbol D₁ indicates a distance between the point P₁ and the point P₂. The details of the point P₁, the point P₂, and the distance D₁ will be described later herein.

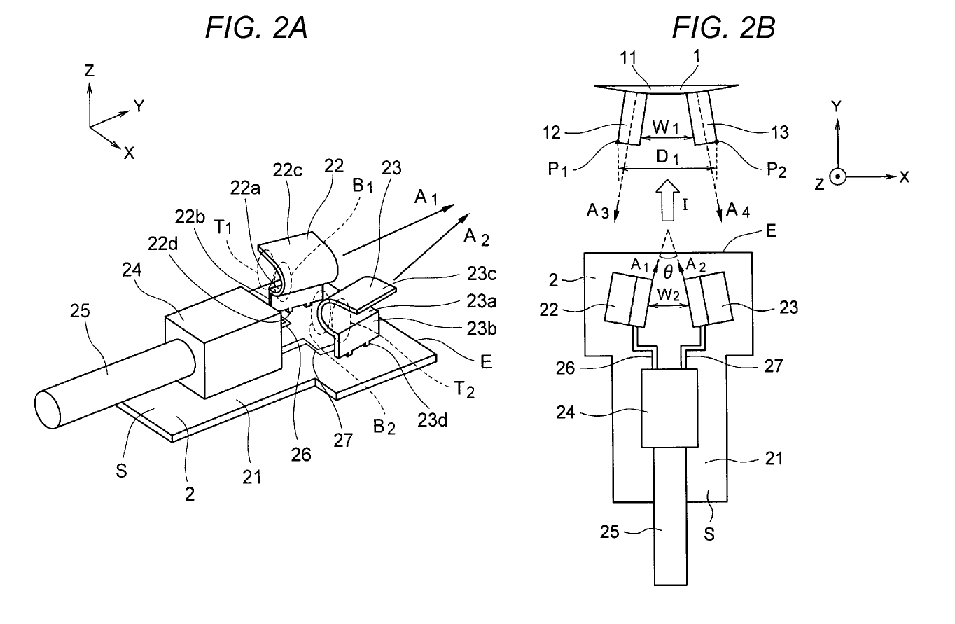

FIGS. 2A and 2B are a perspective view and a plan view, respectively, illustrating the structure of a semiconductor device component 2 according to the first embodiment. FIG. 2A is a perspective view showing the semiconductor device component 2, while FIG. 2B is a plan view showing the semiconductor device component 2.

The semiconductor device component 2 in this embodiment includes a mounting substrate 21, first and second connection terminals 22 and 23 as an example of a semiconductor device terminal, a connector 24, a cable 25, and conductive films 26 and 27.

FIGS. 2A and 2B illustrate the semiconductor device component 2 disposed in such a position that a surface S of the mounting substrate 21 faces the +Z direction. The semiconductor device 1 in this embodiment is used with the semiconductor device component 2 connected with the first and second external terminals 12 and 13.

The first connection terminal 22 is disposed on the surface S of the mounting substrate 21, and includes a first U-shaped portion 22a, a first support portion 22b, a first extension portion 22c, and one or more first insertion portions 22d.

The first U-shaped portion 22a is a concave curved member generally formed by stamping or otherwise forming a flat piece of a conductive material such as a metal in a curved form, such that a surface thereof to which the terminal 12 will be connected via an electrically conductive adherent, such as by soldering with a solder and heat, has a curved surface the base B₁ (root) of which (the inner surface of the U closest to the second connection terminal 23) extends in an A₁ direction parallel with the surface S of the mounting substrate 21 and with direction A₃. The cross-sectional shape of the first U-shaped portion 22a in a plane perpendicular to the A₁ direction is U-shaped. The first connection terminal 22 is disposed in a position such that a U-shaped base B₁ of the first U-shaped portion 22a is located closer to the second connection terminal 23 than the open front T₁ of the first U-shaped portion 22a, which faces away from the second connection terminal 23. The front T₁ of the first U-shaped portion 22a corresponds to an opening of the first connection terminal 22.

The first support portion 22b is connected with, and extends from, a lower end (first end) of the first U-shaped portion 22a, and is interposed between the lower end of the first U-shaped portion 22a and the mounting substrate 21 to support the first U-shaped portion 22a in position to receive terminal 10 (FIG. 1) therein. The first support portion 22b extends in a direction not parallel with (more specifically, perpendicular to) the surface S of the mounting substrate 21 from the lower end of the first U-shaped portion 22a. The cross-sectional shape of the first support portion 22b in a plane perpendicular to the A₁ is linear, i.e., the first support portion is flat. The first U-shaped portion 22a is supported on the mounting substrate 21 via the first support portion 22b.

The first extension portion 22c is connected to, and extends from, an upper end (second end) of the first U-shaped portion 22a, and extends in a direction generally parallel to the surface S of the mounting substrate 21 from the upper end of the first U-shaped portion 22a. The cross-sectional shape of the first extension portion 22c in a plane perpendicular to the A₁ direction is linear, in other words, the first extension portion 22c is flat.

The first insertion portion 22d is connected with a lower end of the first support portion 22b. Attachment of the first connection terminal 22 to the mounting substrate 21 is made by inserting of the first insertion portion 22d into a hole formed in the mounting substrate 21, and thereafter soldering the first insertion portion 22d to the mounting substrate 21. In the embodiment shown in FIG. 2A, two individual first insertion portions 22d extend into the mounting substrate 21 from the base of the first support portion 22b.

The second connection terminal 23 is disposed on the surface S of the mounting substrate 21 adjacent to the first connection terminal 22, and includes a second U-shaped portion 23a, a second support portion 23b, a second extension portion 23c, and one or more second insertion portions 23d.

The second U-shaped portion 23a is a concave curved member generally forming by stamping or otherwise forming a flat piece of a conductor such as a metal in a curved form, such that a surface thereof to which the terminal 13 will be connected via an electrically conductive adherent, such as by soldering with a solder and heat, has a curved surface at the base B₂ (root) thereof which has an inner surface that extends in an A₂ direction parallel with the surface S of the mounting substrate 21 and with direction A₄ not parallel to the direction A₁. The cross-sectional shape of the second U-shaped portion 23a in a plane perpendicular to the A₂ direction is U-shaped. The second connection terminal 23 is disposed in a position such that the U-shaped base B₂ of the second U-shaped portion 23a is located closer to the first connection terminal 22 side of the mounting substrate 21 than is the front T₂ of the second U-shaped portion 23a having the opening thereof facing away from the second U-shaped portion 23a. The front T₂ of the second U-shaped portion 23a corresponds to an opening of the second connection terminal 23.

The second support portion 23b is connected with, and extends from, a lower end (first end) of the second U-shaped portion 23a, and is interposed between the lower end of the second U-shaped portion 23a and the mounting substrate 21. The second support portion 23b extends in a direction not parallel with (more specifically, perpendicular to) the surface S of the mounting substrate 21 from the lower end of the second U-shaped portion 23a. The cross-sectional shape and the function of the second support portion 23b are similar to those of the first support portion 22b.

The second extension portion 23c is connected with an upper end (second end) of the second U-shaped portion 23a, and extends in a direction parallel with the surface S of the mounting substrate 21 from the upper end of the second U-shaped portion 23a and on the opening side thereof. The cross-sectional shape and the function of the second extension portion 23c are similar to those of the first extension portion 22c.

The second insertion portion 23d is connected with a lower end of the second support portion 23b. The shape, number and the function of the second insertion portion 23d are similar to those of the first insertion portion 22d.

The first connection terminal 22 and the second connection terminal 23 in this embodiment have mirror-symmetric shapes. In this case, the first connection terminal 22 and the second connection terminal 23 are disposed in such positions as to be mirror-symmetric with respect to a plane perpendicular to the surface S of the mounting substrate 21 (Y-Z plane in this embodiment). A reference sign θ indicates the angle formed by the A₁ direction and the A₂ direction. According to this embodiment, the angle formed by the A₁ direction and the A₂ direction is set to be equal to the angle formed by the A₃ direction and the A₄ direction.

The first connection terminal 22 and the second connection terminal 23 in this embodiment are shown disposed in the vicinity of, and spaced from, an end surface E of the mounting substrate 21 in FIG. 2B. A reference sign W₂ indicates the distance between the first connection terminal 22 and the second connection terminal 23. According to this embodiment, the distance W₂ between the first connection terminal 22 and the second connection terminal 23 decreases in the direction toward the end surface E.

A connector 24 is disposed on the surface S of the mounting substrate 21, and has the function of electrically connecting the first and second connection terminals 22 and 23 to the shield and signal lines in a cable 25. The cable 25 is a coaxial cable including a signal line and a shield line, for example. The first and second connection terminals 22 and 23 are electrically connected with the connector 24 via conductive films 26 and 27 provided on the surface S of the mounting substrate 21.

The first and second connection terminals 22 and 23 may be electrically connected with the connector 24 by conductive films provided on the surfaces of the mounting substrate 21 on both sides, and a through hole electrode (not shown) of the mounting substrate 21 for connecting the respective conductive films.

The semiconductor device component 2 in this embodiment is connected with the first and second connection terminals 22 and 23 by insertion of the first and second external terminals 12 and 13 into the first and second U-shaped portions 22a and 23a. An arrow I indicates the movement direction of the semiconductor device component 2 at the time of insertion of the first and second external terminals 12 and 13 into the first and second U-shaped portions 22a and 23a. The I direction corresponds to the direction in which the semiconductor device component 2 approaches the semiconductor device 1, or vice-versa. After being inserted into the first and second U-shaped portions 22a and 23a, the first and second external terminals 12 and 13 in this embodiment are electrically and mechanically joined to the first and second U-shaped portions 22a and 23a by soldering them together.

The first connection terminal 22 in this embodiment is disposed in such a position that the front (opening) T₁ of the first U-shaped portion 22a faces away from the second connection terminal 23. On the other hand, the front (opening) T₂ of the second connection terminal 23 in this embodiment faces away from the first connection terminal 22. According to this embodiment, therefore, easy insertion of the radially disposed first and second external terminals 11 and 12 into the first and second U-shaped portions 22a and 23a is allowed by movement of the semiconductor device component 2 in the I direction, or of the semiconductor device 1 in the direction of the semiconductor device component 2 in opposition to the I direction. Because the surface of the bases B₁ and B₂ are parallel to the terminals 12 and 13 which extend along radii A₃ and A₄, the sides of the terminals 12 and 13 will approach the root of the base and be received within the U shaped portion as the semiconductor device component 2 and the semiconductor device 1 are brought together.

Moreover, the first and second connection terminals 22 and 23 in this embodiment have the first and second extension portions 22c and 23c connected with the first and second U-shaped portions 22a and 23a, respectively, which in turn are secured in the mounting substrate 21. Thus, the first and second extension portions 22c and 23c are in a fixed relatively position when placed on the first and second external terminals 12 and 13 during soldering of the first and second external terminals 12 and 13, and the position of the semiconductor device component 2 and terminals 12, 13 are also relatively fixed during this step. Accordingly, the working efficiency of the soldering step in this embodiment improves, because secondary holding fixtures or the like are not needed to position the terminals 12, 13 in position to be soldered to the connection terminals 22 and 23 and thus the connector is inherently supported during the soldering step.

Additionally, if the solder at the first insertion portion 22d of the first connection terminal 22 is re-melted by heat generated during soldering of the first external terminal 12, the second external terminal 13 supports the semiconductor device component 2 relative to the semiconductor device. When the re-melting occurs before the soldering of the second external terminal 13, the semiconductor device component 2 is supported by engagement between the second extension portion 23c of the second connection terminal 23 and the second external terminal 13. On the other hand, when the re-melting occurs after the soldering of the second external terminal 13, the semiconductor device component 2 is supported by connection of the second external terminal 13 to the second connection terminal 23 via the solder.

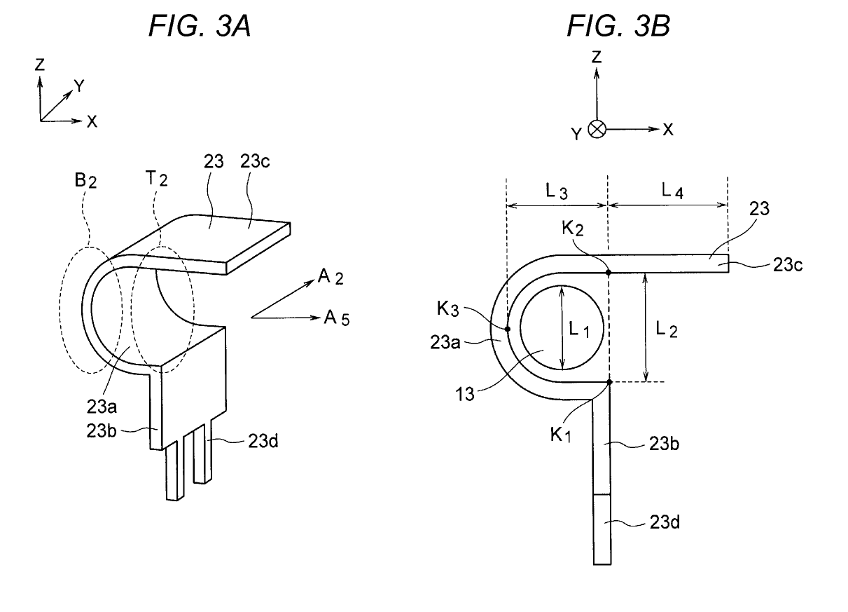

FIGS. 3A and 3B are a perspective view and a cross-sectional view, respectively, illustrating the structure of the second connection terminal 23 according to the first embodiment. FIG. 3A is a perspective view of the second connection terminal 23, while FIG. 3B is a side view of the second connection terminal 23. FIGS. 3A and 3B illustrate the second connection terminal 23 disposed in such a position that the A₂ direction extends in the +Y direction. The following explanation is also applicable to the first connection terminal 22.

As noted above, the second connection terminal 23 includes the second U-shaped portion 23a, the second support portion 23b, the second extension portion 23c, and the one or more second insertion portions 23d.

The second U-shaped portion 23a has a shape extending in the A₂ direction. The shape of the second U-shaped portion 23a in a plane perpendicular to the A₂ direction is U-shaped. An arrow A₅ indicates the direction from the U-shaped base B₂ toward the front T₂ of the second connector 23. FIG. 3A shows the second connection terminal 23 disposed in such a position that the A₅ direction extends in the +X direction.

The second support portion 23b is connected with, and extends from, the lower end of the second U-shaped portion 23a. The shape of the second support portion 23b in a plane perpendicular to the A₂ direction is flat extending in a direction not parallel with (more specifically, perpendicular to) the A₅ direction.

The second extension portion 23c is connected with, and extends from, the upper end of the second U-shaped portion 23a. The shape of the second extension portion 23c in a plane perpendicular to the A₂ direction is flat extending in a direction parallel with the A₅ direction.

The second insertion portion 23d is connected with, and extends from, the lower end of the second support portion 23b. The second insertion portion 23d has a bar shape extending in the same direction as the extension direction of the second support portion 23b.

FIG. 3B shows points K₁, K₂, and K₃ on the inner wall surface of the second U-shaped portion 23a. The point K₁ is located at the lower end (first end) of the second U-shaped portion 23a, while the point K₂ is located at the upper end (second end) of the second U-shaped portion 23a. The point K₃ is located at the tip of the base B₂ of the second U-shaped portion 23a.

A reference sign L₁ indicates a diameter of the second external terminal 13. A reference sign L₂ indicates a distance between the point K₁ and the point K₂, i.e., a distance between the lower end and the upper end of the second U-shaped portion 23a. The distance L₂ corresponds to the opening width at the front (opening) T₂ of the second U-shaped portion 23a. According to this embodiment, the distance L₂ is greater than the diameter L₁ (L₂>L₁) so as to allow insertion and receipt of the second external terminal 13 into the second U-shaped portion 23a.

A reference sign L₃ indicates a distance between the point K₁ (or K₂) and the point K₃ in the A₅ direction. The distance L₃ corresponds to the U-shaped depth of the second U-shaped portion 23a. According to this embodiment, the distance L₃ is greater than the distance L₁ (L₂>L₁) so as to allow the second external terminal 13 to be fully received within the envelope of the second U-shaped portion 23a, i.e., so that the terminal need not extend outwardly from a plane defined by an imaginary extension of the second extension portion along the dashed line extending across the front of the U-shaped opening in FIG. 3B (separating dimensions L₃ and L₄.

Reference symbol L₄ indicates the length of the second extension portion 23c in the A₅ direction. It is preferable that the length L₄ is set at such a length allowing the second extension portion 23c to be easily located on the second external terminal 13 during the solder connection operation connecting the first and second connection terminals 22 and 23 to terminals 12 and 13.

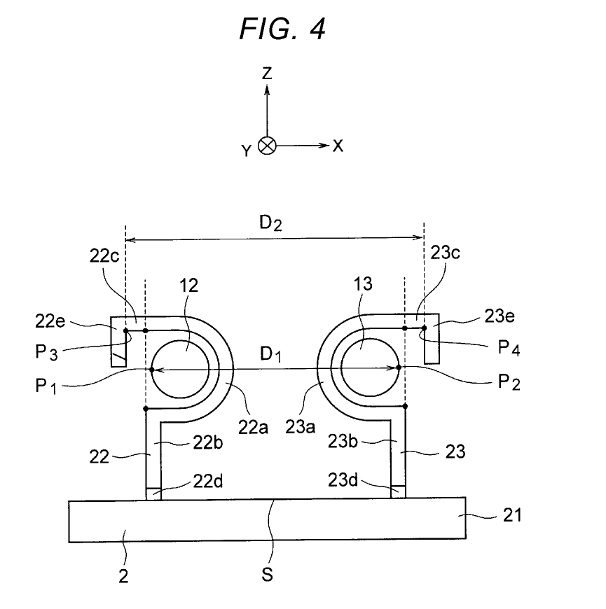

FIG. 4 is a cross-sectional view illustrating the structure of the semiconductor device component 2 according to a modified example of the first embodiment. The cross-sectional view of FIG. 4 shows the cross section of the semiconductor device component 2 in planes perpendicular to the A₁ and A_{z} directions and passing through the first and second connection terminals 22 and 23.

For convenience of depiction of the figure, the first and second connection terminals 22 and 23 illustrated in FIG. 4 are in such a condition that both the directions A₁ and A₂ extend in the +Y direction. However, it is assumed that the semiconductor device component 2 discussed in the following description is positioned such that the A₁ and A₂ directions extend in the directions shown in FIGS. 2A and 2B.

In this modified example, the first connection terminal 22 includes the first U-shaped portion 22a, the first support portion 22b, the first extension portion 22c, the first insertion portion 22d, and further a first bent portion 22e. The first bent portion 22e is connected with, and extends from, an end of the first extension portion 22c. The cross-sectional shape of the first bent portion 22e in a plane perpendicular to the A₁ direction is of a flat shape extending in a direction not parallel with (for example, perpendicular to) the first extension portion 22c. The cross-sectional shape of the first bent portion 22e may be a shape other than the flat shape.

The second connection terminal 23 includes the second U-shaped portion 23a, the second support portion 23b, the second extension portion 23c, the second insertion portion 23d, and further a second bent portion 23e. The second bent portion 23e is connected with an end of the second extension portion 23c. The cross-sectional shape of the second bent portion 23e in a plane perpendicular to the A₂ direction is in a flat shape extending in a direction not parallel with (for example, perpendicular to) the second extension portion 23c. The cross-sectional shape of the second bent portion 23e may be a shape other than the linear shape.

The reference sign P₁ indicates a point located on the distal end surface on the circumference of the first external terminal 12 at a position furthest from the base 23a of the second external terminal 13 (see FIG. 1B). Similarly, the reference sign P₂ indicates a point located on the distal end surface of the second external terminal 13 at a position on the circumference thereof furthest from the first external terminal 12. The reference sign D₁ indicates the distance between the point P₁ and the point P₂.

On the other hand, a reference sign P₃ indicates a point located at the end of the inner wall surface of the first bent portion 22a in the +X direction, while a reference sign P₄ indicates a point located at the end of the inner wall surface of the second bent portion 23a in the −X direction. A reference sign D₂ indicates a distance between the point P₃ and the point P₄.

If the distance D₂ is shorter than the distance D₁, insertion of the first and second external terminals 12 and 13 into the first and second U-shaped portion 22a and 23a becomes difficult because the surfaces of the connection terminals 22, 23 will interferingly engage the ends of the terminals 12, 13. According to this embodiment, therefore, the distance D₂ is set to be greater than the distance D₁ (D₂>D₁).

When the distance D₂ is greater than the distance D₁ with only a small difference between the distance D₁ and the distance D₂, there is a high possibility of interference between the first and second external terminals 12 and 13 and the first and second bended portions 22e and 23e at the time of insertion. According to this embodiment, therefore, it is preferable that the distance D₂ is set to be sufficiently greater than the distance D₁ to avoid such interference. For example, it is preferable that the distance D₂ is set to be greater than the sum of the distance D₁ and the diameter L₁ of each of the first and second external terminals 12 and 13 (D₂>D₁+L₁).

In other words, according to this embodiment, the first and second bent portions 22e and 23e may be formed on the first and second connection terminals 22 and 23, respectively, when this structure is configured to allow insertion of the first and second external terminals 12 and 13 into the first and second U-shaped portions 22a and 23a without interference. In this case, it is preferable to set the distance D₂ sufficiently to be greater than the distance D₁ for easy insertion of the first and second external terminals 12 and 13 into the first and second U-shaped portions 22a and 23a.

Accordingly, the first connection terminal 22 in this embodiment is disposed in such a position that the U-shaped base B₁ of the first U-shaped portion 22a is located adjacent to the second connection terminal 23, and the U-shaped front T₁ of the first U-shaped portion 22a faces away from the second connection terminal 23.

Moreover, the second connection terminal 23 in this embodiment is disposed in such a position that the U-shaped base B₂ of the second U-shaped portion 23a is located adjacent to the first connection terminal 22, and the U-shaped front T₂ of the second U-shaped portion 23a faces away from the first connection terminal 22.

According to this embodiment, therefore, the first and second external terminals 12 and 13 extending not in parallel with each other are able to easily connect with the mounting substrate 21 by using the first and second connection terminals 22 and 23.

The U shape of the cross-sectional shape of the first and second U-shaped portions 22a and 23a may be modified into other various shapes. For example, the U-shape may be constituted only by a semicircular shape, or a semicircular shape and two lines connected to two ends of the semicircular shape. The semicircular shape of the latter example may be modified into a shape formed by planes. In this case, the U-shape becomes a rectangular shape from which one side is removed. The semicircular shape of each of the former and the latter examples may be modified into a semielliptic shape.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device component, comprising:
a mounting substrate;
a first connection terminal disposed on the mounting substrate, having a shape extending in a first direction parallel with a surface of the mounting substrate, and comprising a first U-shaped portion having a U-shaped cross-sectional shape in a plane perpendicular to the first direction; and
a second connection terminal, disposed on the mounting substrate, adjacent to the first connection terminal, having a shape extending in a second direction parallel with the surface of the mounting substrate and not parallel with the first direction, and comprising a second U-shaped portion having a U-shaped cross-sectional shape in a plane perpendicular to the second direction, wherein:
the first connection terminal is disposed in such a position that a U-shaped base of the first U-shaped portion is located adjacent to a second connection terminal, and
the second connection terminal is disposed in such a position that a U-shaped base of the second U-shaped portion is located adjacent to a first connection terminal.

2. The component according to claim 1, wherein
the first and second connection terminals are disposed in the vicinity of an end surface of the mounting substrate, and
a distance between the first U-shaped portion and the second U-shaped portion decreases in the direction of the end surface.

3. The component according to claim 1, wherein
the first connection terminal further comprises:
a first support portion interposed between a first end of the first U-shaped portion and the mounting substrate, and
a first extension portion extending in a direction parallel with the surface of the mounting substrate from a second end of the first U-shaped portion, and
the second connection terminal further comprises:
a second support portion interposed between a first end of the second U-shaped portion and the mounting substrate, and
a second extension portion extending in a direction parallel with the surface of the mounting substrate from a second end of the second U-shaped portion.

4. A connector for connection to a first and a second terminal extending along two different radii from a point, comprising:
a base;
a first connection terminal supported from the base and including a concave receiving portion within which a first of the terminals is to be received;
a second connection terminal supported from the base and including a concave receiving portion within which a second of the terminals is to be received;
the concave portion of the first terminal facing away from the concave portion of the second terminal.

5. The connector of claim 4, wherein the base of the concave receiving portion of the first connection terminal extends along a first direction;
the base of the concave receiving portion of the second connection terminal extends along a second direction; and
the first and second directions are offset from one another by the angle theta.

6. The connector of claim 5, wherein at least one of the connection terminals includes an extending portion extending from a surface thereof parallel to the base.

7. The connector of claim 5, wherein at least one of the connection terminals includes an extending portion extending from a surface thereof parallel to the base and a further extension extending from the extension in the direction of the base.

8. The connector of claim 5, wherein at least one of the first and second connection terminals includes a support portion extending upwardly from the base and terminating at the concave portion, the support including at least one insertion portion extending therefrom and received in the base.

9. The connector of claim 8, wherein the base includes a cable connector mounted thereon, and a first conductive line extending on the base from the cable connector to the first terminal.

10. The connector of claim 9, wherein the insertion portion is interconnected to the base by solder, and the solder extends to be in contact with the conductive line.

11. The connector of claim 9, wherein the gap between the first and second connection terminals decreases as the distance along a side of the first and second connection terminals from the cable connector increases; and
the smallest gap between the inner surfaces at the base of the convex portions of the first and second connection terminals is greater than the smallest gap between the first and second terminals.

12. The connector of claim 5, further including solder interposed and connecting the first terminal within the concave portion of the first connection terminal and solder interposed and connecting the second terminal within the concave portion of the second connection terminal.

13. The connector of claim 12, wherein at least the first connector has an extension extending from the concave portion over the first terminal.

14. A method of attaching a first and a second terminal extending along different paths at an angle theta with respect to each other to a connector, comprising:
providing a connector having a base, a first and a second connection terminal extending therefrom, the connection terminals including concave portions facing away from one another, the concave portions each having a base surface extending in a direction, such that the direction of the base surface of the base of the first connection terminal and the direction of the surface of the base of the second connection terminal are offset at an angle with respect to one another;
moving the base in the direction of the first and second terminals such that the first terminal is received in the concave portion of the first connection terminal and the second terminal is received in the concave portion of the second connection terminal, without otherwise supporting the terminals or the connection terminals; and
adherently interconnecting the first terminal and first connection terminal, and the second terminal and second connection terminal, with an electrically conductive adherent.

15. The method of claim 14, further comprising:
providing solder as the adherent; and
positioning the connection terminals on the terminals during soldering of the first and second terminals to the first and second connection terminals to inherently maintain the position of the connector with respect to the terminals.

16. The method of claim 15, wherein the first and the second connection terminals are connected to the base by a solder connection by: heating the solder provided as an adherent to interconnect the first terminal and first connection terminal, and thereby heating the solder connecting the first connection terminal and the base to a temperature above the flow temperature of that solder; and
allowing contact between the second connection terminal and the second terminal to maintain the position of the connector with respect to the first and second terminals during the soldering of the first terminal to the first connection terminal.

17. The method of claim 16, wherein the first and second connection terminals are spaced from the base by a support, and the support includes at least one projection extending therefrom into an aperture in the base, and the extension is solder connected to the base.

18. The method of claim 16, further comprising:
positioning an extension on the first and the second connection terminals to overly and extend from the first terminal and the second terminal.

19. The method of claim 18, wherein the concave portion, the support, and the extension on the first and second connection terminals are formed from a single piece of material.

20. The method of claim 14, wherein the angle between the base portions surfaces and the angle theta are the same angle.
